(19) United States
(12) Patent Application Publication
(10) Pub. No.: US 2017/0206898 A1
(43) Pub. Date: Jul. 20, 2017

(54) SYSTEMS AND METHODS FOR ASSISTING AUTOMATIC SPEECH RECOGNITION

(71) Applicant: Knowles Electronics, LLC, Itasca, IL (US)

(72) Inventors: Alexis Bernard, Itasca, IL (US); Chetan S. Rao, Itasca, IL (US)

(73) Assignee: Knowles Electronics, LLC, Itasca, IL (US)

(21) Appl. No.: 15/404,958

(22) Filed: Jan. 12, 2017

Related U.S. Application Data
(60) Provisional application No. 62/278,864, filed on Jan. 14, 2016.

(51) Int. Cl. G10L 15/22; G10L 15/30; G10L 21/0232

(52) U.S. Cl. CPC G10L 15/22; G10L 21/0232; G10L 15/30; G10L 2021/02082

(57) ABSTRACT

Systems and methods for assisting automatic speech recognition (ASR) are provided. An example method includes generating, by a mobile device, a plurality of instantiations of a speech component in a captured audio signal, each instantiation of the plurality of instantiations being in support of a particular hypothesis regarding the speech component. At least two instantiations of the plurality of instantiations are then sent to a remote ASR engine. The remote ASR engine is configured to recognize at least one word based on the at least two of the plurality of instantiations and a user context, according to various embodiments. This recognition can include selecting one of the instantiations of the speech component from the plurality of instantiations. The plurality of instantiations may be generated by noise suppression of the captured audio signal with different degrees of aggressiveness. In some embodiments, the plurality of instantiations is generated by synthesizing the speech component from synthetic speech parameters obtained by a spectral analysis of the captured audio signal.

### CROSS-REFERENCE TO RELATED APPLICATIONS

The present application claims priority from U.S. Prov. Appln. No. 62/278,864 filed Jan. 14, 2016, the contents of which are incorporated by reference herein in their entirety.

### BACKGROUND

ASR, and, specifically, cloud-based ASR are widely used in operation of mobile device interfaces. Many of the mobile devices are provided with functionality for speech recognition of the speech of users. Speech may include spoken commands for performing local operations of the mobile device and/or commands to be executed using computing cloud services. As a rule, the speech (even if it includes a local command) is sent for recognition to a cloud-based ASR engine since any task of speech recognition requires large computing resources which are not readily available on the mobile device. After being processed for recognition by the cloud-based ASR, the commands, as recognized, are sent back to the mobile device. Consequently, there is a delay introduced between speech being received by the mobile device and the execution of the commands due to the time required for sending the speech to the computing cloud, processing the speech by the computing cloud, and sending the recognized command back to the mobile device. Further improvements in cloud-based ASR systems are needed in order to reduce the time for processing of speech. In addition, further improvements are needed in order to also increase the probability of making a correct recognition of the speech.

### SUMMARY

Systems and methods for assisting automatic speech recognition (ASR) are provided. The method may be practiced on mobile devices communicatively coupled to one or more cloud-based computing resources.

Various embodiments of the present technology improve speech recognition by sending multiple instantiations (e.g., multiple pre-preprocessed audio files) in support of particular hypotheses to the remote ASR engine (e.g., Google's speech recognizer, Nuance, iFlytek, and so on) for speech recognition and by allowing the remote ASR engine to select one or more optimal instantiations based on context information available to the ASR engine. Each instantiation may be an audio file that can be processed by a local ASR assisting method (e.g., ASR Assist technology) on the mobile device (e.g., by performing noise suppression and echo cancellation). In various embodiments, each of the instantiations represents a “guess” (i.e., an estimate) regarding the waveform of the clean speech signal.

The remote ASR engine may have access to background and context information associated with the user, and, therefore, the remote ASR engine can be in a better position to select the optimal instantiation. Thus, by sending (transmitting) multiple instantiations to the remote ASR engine so as to allow the remote ASR engine to make the selection of the optimal waveform, according to various embodiments, speech recognition can be improved.

According to an example of the present disclosure, a method for assisting ASR includes generating, by a mobile device, a plurality of instantiations of a speech component in a captured audio signal. Each instantiation is based on particular hypothesis for the speech component. The example method includes sending at least two of the plurality of instantiations to a remote ASR engine. The ASR engine may be configured for recognizing at least one word based on at least the plurality of instantiations and a user context.

In some embodiments, the plurality of instantiations in support of particular hypotheses is generated by performing noise suppression of the captured audio signal using different degrees of aggressiveness. In other embodiments, the plurality of instantiations is generated by synthesizing the speech component from synthetic speech parameters. The synthetic speech parameters can be obtained using a spectral analysis of the captured audio signal.

### BRIEF DESCRIPTION OF THE DRAWINGS

FIG. 1 is a block diagram illustrating an environment in which methods for assisting automatic speech recognition can be practiced, according to various example embodiments.

FIG. 2 is a block diagram illustrating a mobile device, according to an example embodiment.

FIGS. 3A, 3B, and 3C illustrate various example embodiments for sending the audio signal data to a remote ASR engine.

FIG. 4 is a block diagram of an example audio processing system suitable for practicing a method of assisting ASR, according to various example embodiments of the disclosure.

FIG. 5 is a flow chart showing a method for assisting ASR, according to an example embodiment.

FIG. 6 illustrates an example of a computer system that may be used to implement various embodiments of the disclosed technology.

### DETAILED DESCRIPTION

The technology disclosed herein relates to systems and methods for assisting ASR. Embodiments of the present technology may be practiced with any mobile devices operable at least to capture acoustic signals.

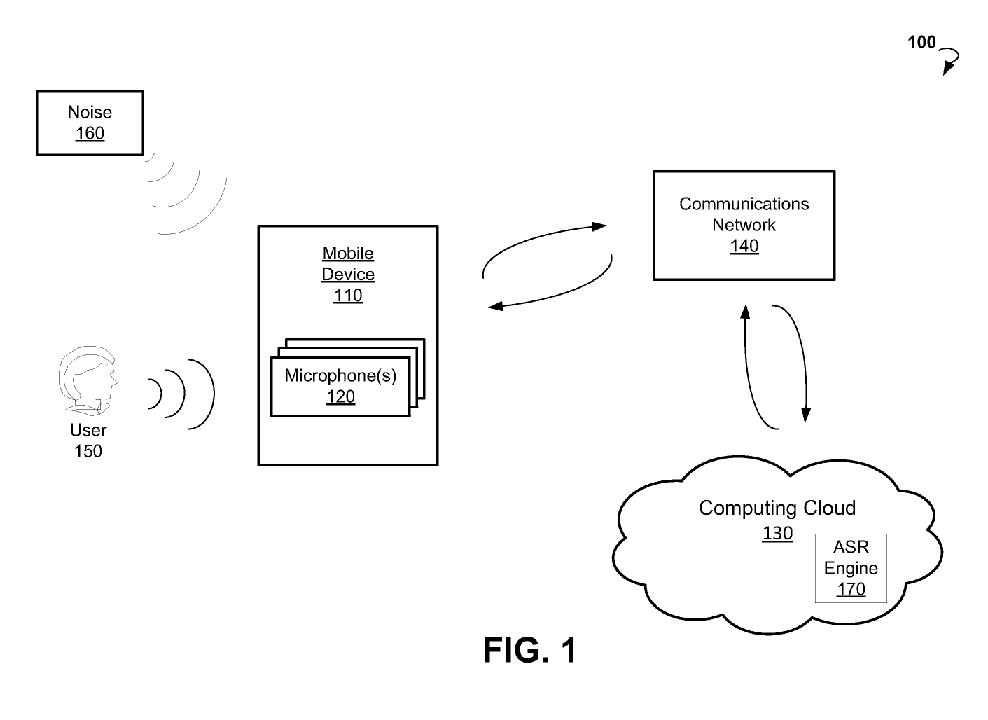

Referring now to FIG. 1, an example environment 100 is shown in which a method for assisting ASR can be practiced. Example environment 100 includes a mobile device 110 and one or more cloud-based computing resource(s) 130, also referred to herein as a computing cloud(s) 130 or cloud 130. The cloud-based computing resource(s) 130 can include computing resources (hardware and software) available at a remote location and accessible over a network (for example, the Internet). In various embodiments, the cloud-based computing resource(s) 130 are shared by multiple users and can be dynamically re-allocated based on demand. The cloud-based computing resource(s) 130 include one or more server farms/clusters, including a collection of computer servers which can be co-located with network switches and/or routers. In various embodiments, the computing cloud 130 provides computational services upon request from mobile device 110, including but not limited to an ASR engine 170. In various embodiments, the mobile device 110 can be connected to the computing cloud 130 via one or more wired or wireless communications networks 140. In various embodiments, the mobile device 110 is operable to send data (for example, captured audio signals) to cloud 130 for processing (for example, for performing ASR) and receive back the result of the processing (for example, one or more recognized words).

In various embodiments, the mobile device 110 includes microphones (e.g., transducers) 120 configured to receive voice input/acoustic sound from a user 150. The voice input/acoustic sound may be contaminated by a noise 160. Sources of the noise can include street noise, ambient noise, speech from entities other than an intended speaker(s), and the like.

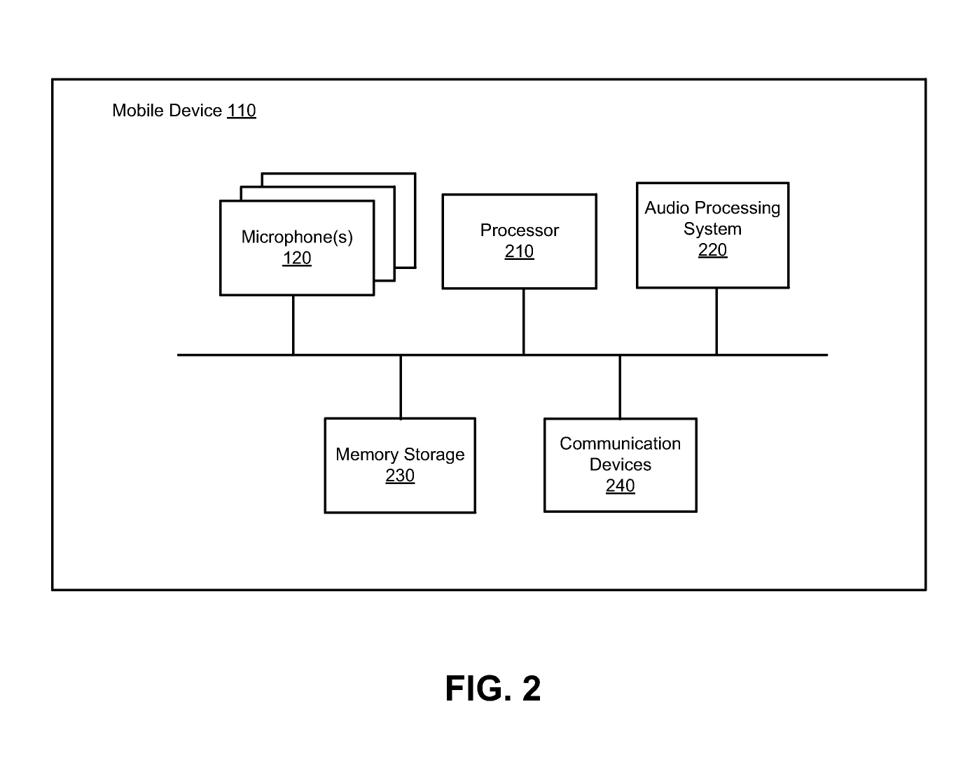

FIG. 2 is a block diagram showing components of the mobile device 110, according to various example embodiments. In the illustrated embodiment, the mobile device 110 includes one or more microphones 120, a processor 210, audio processing system 220, a memory storage 230, and one or more communication devices 240. The mobile device 110 may also include additional or other components necessary for operations of mobile device 110. In other embodiments, the mobile device 110 includes fewer components that perform similar or equivalent functions to those described with reference to FIG. 2.

In various embodiments, where the microphones 120 include multiple omnidirectional microphones closely spaced (e.g., 1-2 cm apart), a beam-forming technique can be used to simulate a forward-facing and a backward-facing directional microphone response. A level difference can be obtained using simulated forward-facing and backward-facing directional microphones. The level difference can be used to discriminate speech and noise in, for example, the time-frequency domain, which can be further used in noise and/or echo reduction. In certain embodiments, some microphones 120 are used mainly to detect speech and other microphones 120 are used mainly to detect noise. In yet other embodiments, some microphones 120 can be used to detect both noise and speech.

In various embodiments, the acoustic signals, once received, for example, captured by microphones 120, can be converted into electric signals, which, in turn, are converted, by the audio processing system 220, into digital signals for processing. In some embodiments, the processed signals can be transmitted for further processing to the processor 210.

Audio processing system 220 may be operable to process an audio signal. In some embodiments, acoustic signals are captured by the microphone(s) 120. In certain embodiments, acoustic signals detected by the microphone(s) 120 are used by audio processing system 220 to separate speech from the noise. Noise reduction may include noise cancellation and/or noise suppression and echo cancellation. By way of example and not limitation, noise reduction methods are described in U.S. patent application Ser. No. 12/215,980, entitled “System and Method for Providing Noise Suppression Utilizing Null Processing Noise Subtraction,” filed Jun. 30, 2008, now U.S. Pat. No. 9,185,487, and in U.S. patent application Ser. No. 11/699,732, entitled “System and Method for Utilizing Omni-Directional Microphones for Speech Enhancement,” filed Jan. 29, 2007, now U.S. Pat. No. 8,194,880, which are incorporated herein by reference in their entireties.

In various embodiments, the processor 210 includes hardware and/or software operable to execute computer programs stored in the memory storage 230. The processor 210 can use floating point operations, complex operations, and other operations, including hierarchical assignment of recognition tasks. In some embodiments, the processor 210 of the mobile device 110 comprises, for example, at least one of a digital signal processor, image processor, audio processor, general-purpose processor, and the like.

The exemplary mobile device 110 is operable, in various embodiments, to communicate over one or more wired or wireless communications networks 140 (as shown in FIG. 1), for example, via communications devices 240. In some embodiments, the mobile device 110 can send at least audio signal containing speech over a wired or wireless communications network 140. The mobile device 110 may encapsulate and/or encode the at least one digital signal for transmission over a wireless network (e.g., a cellular network).

The digital signal may be encapsulated over Internet Protocol Suite (TCP/IP) and/or User Datagram Protocol (UDP). The wired and/or wireless communications networks 140 (shown in FIG. 1) may be circuit switched and/or packet switched. In various embodiments, the wired communications network(s) provide communication and data exchange between computer systems, software applications, and users, and include any number of network adapters, repeaters, hubs, switches, bridges, routers, and firewalls. The wireless communications network(s) include any number of wireless access points, base stations, repeaters, and the like. The wired and/or wireless communications network(s) may conform to an industry standard(s), proprietary, and combinations thereof. Various other suitable wired and/or wireless communications network(s), other protocols, and combinations thereof, can be used.

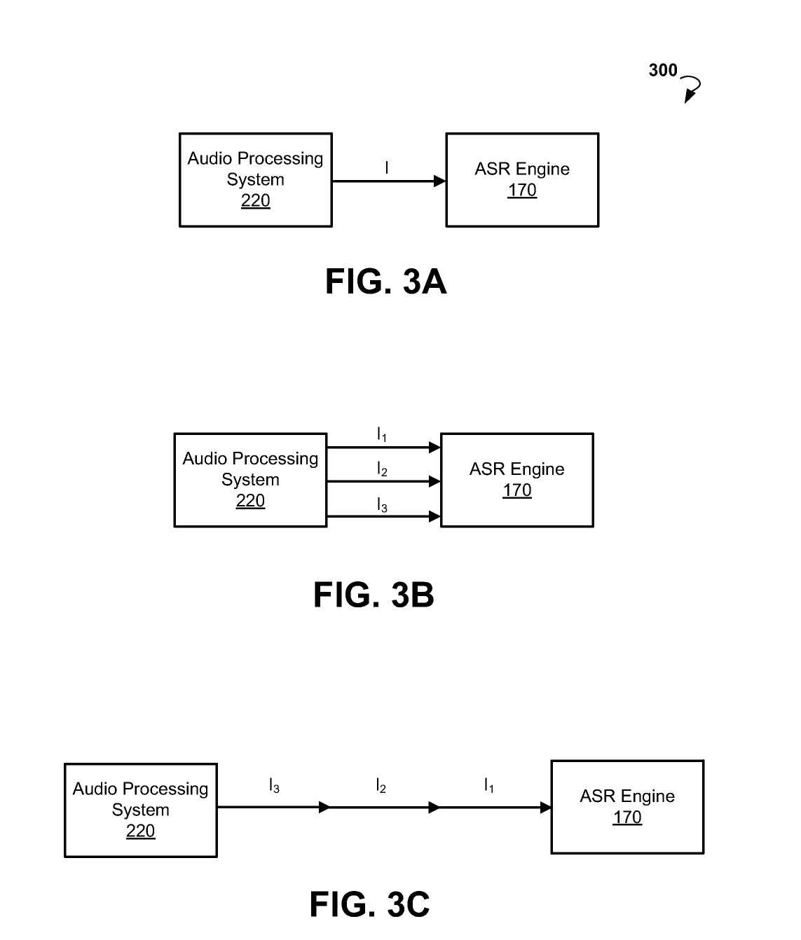

FIG. 3A is block diagram showing an example system 300 for assisting ASR. The system 300 includes at least an audio processing system 220 (also shown in FIG. 2) and an ASR engine 170 (also shown in FIG. 1). In some embodiments, the audio processing system 220 is part of the mobile device 110 (shown in FIG. 1), while the ASR engine 170 is provided by a cloud-based computing resource(s) 130 (shown in FIG. 1).

In certain embodiments, the audio processing system 220 is operable to receive input from one or more microphones of the mobile device 110. The input may include waveforms corresponding to an audio signal as captured by the different microphones. In some embodiments, the input further includes waveforms of the audio signal captured by devices other than the mobile device 110 but located in the same environment. The audio processing system 220 can be operable to analyze differences in microphone inputs and, based on the differences, separate a speech component and a noise component in the captured audio signal. In various embodiments, the audio processing system 220 is further operable to suppress or reduce the noise component in the captured audio signal to obtain a clean speech signal. The clean speech signal can be sent to the ASR engine 170 for speech recognition to, for example, determine one or more words in the clean speech.

In the existing technologies, only a single instantiation of the clean speech representing a best estimate (also referred to as best guess or best hypothesis, and as “I” in the example in FIG. 3A) of what speech in the captured audio signal is sent to the ASR engine for the speech recognition. Thus, a best guess was formed and only it was sent to the ASR engine since any instantiation that was not the best was not considered useful to the ASR engine (and may not even have been considered to be a useful instantiation at all if it was not deemed the best. In fact, there might be only one guess.)

In contrast, according to various embodiments of the present disclosure, instead of sending just a single instantiation (e.g., in support of the best estimate) to the ASR engine 170, multiple instantiations (each in support of a particular hypothesis), for example, a pre-determined number of the first most probable instantiations are sent to ASR engine 170. Each of the instantiations, in this example, represents a pre-processed audio signal obtained from the captured audio signal performed by the audio processing system 220.

According to various embodiments, noise suppression in the captured audio signal can be performed more or less aggressively. Aggressive noise suppression attenuates both the speech component and the noise in the captured audio signal. The Voice Quality of Speech (VQOS) depends on the aggressiveness with which the noise suppression is performed. In the existing technologies, an audio processing system can select one noise-suppressed signal (e.g., a best instantiation, based on aggressiveness that was used) and then send the selected signal to ASR engine 170. According to various embodiments of the present disclosure, multiple different noise suppressed signals (e.g., multiple instantiations in support of particular hypotheses), each with a different VQOS can be generated, with multiple ones being sent to ASR engine 170. Similarly, in some embodiments, directional data (including omni-directional data) associated with the audio data and user environment may be sent to the ASR engine 170. By way of example and not limitation, methods having directional data associated with the audio data are described in U.S. patent application Ser. No. 13/735,446, entitled “Directional Audio Capture Adaptation Based on Alternative Sensory Input,” filed Jan. 7, 2013, issued as U.S. Pat. No. 9,197,974 on Nov. 24, 2015, which is incorporated herein by reference in its entirety.

In some embodiments, two or more instantiations (I1, I2, . . . , In) of the clean speech obtained from the captured audio signal are sent to ASR engine 170 in parallel (as shown in FIG. 3B). In other embodiments, the hypotheses are sent serially (as shown in FIG. 3C). In further embodiments, the hypotheses can be sent serially in order from the best VQOS to the worst VQOS.

In some embodiments, each of the instantiations, in support of a particular hypothesis, represents a noise suppressed audio signal captured with a certain pair of microphones. The clean speech may be obtained using differences of waveforms and time of arrival of the acoustic audio signal at each of the microphones in the pair. In further embodiments, the instantiations are generated using different pairs of microphones of the same mobile device. In other embodiments, the instantiations are generated using pairs of microphones belonging to different mobile devices.

ASR engine 170 is operable to receive the multiple instantiations of the clean speech and decide which of the instantiations is most suitable. The decision can be made variously based on user preferences, a user profile, a context associated with the user, or a weighted average of the instantiations. In some embodiments, the user context includes parameters, such as the user's search history, location, user e-mails, and so forth that are available to the ASR engine 170. In other embodiments, the context information is based on previous instantiations that have been sent within a pre-determined time period before the current instantiations. ASR engine 170 can process all of the received instantiations and generate a result (e.g., recognized words) based on all of the received instantiations and the context information. In some embodiments, all received instantiations are processed with the ASR engine 170, and results of the speech recognition for all the received instantiations of the clean speech corresponding to a certain time frame can be saved in a computing cloud for a predetermined time in order to be used as context for the further instantiations corresponding to an audio signal captured within a next time frame.

For example, suppose that 3 different instantiations (IL, I2, and I3) of clean speech have been sent to the ASR engine 170. The ASR engine 170 can recognize that these three instantiations correspond to words “table,” “apple,” and “maple”. All three words can be included in the user context that is used to determine the best result for the next set of instantiations sent to ASR engine 170 and corresponding to the next time frame.

If only one instantiation was selected which is the best on average of all the hypotheses and then sent to ASR engine 170, then just a local optimum of the clean speech is selected. In contrast, if all of the instantiations are sent to the ASR engine 170, according to various embodiments, then the ASR engine 170 can choose the speech signal deemed optimal from each waveform at each point in time, thereby providing an overall/global optimum for the clean speech.

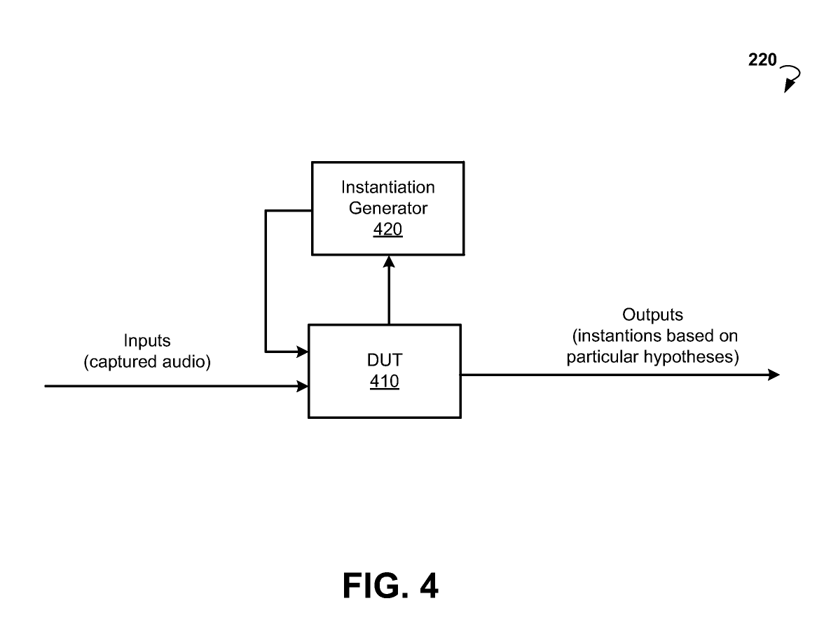

FIG. 4 is a block diagram showing an example audio processing system 220 suitable for assisting ASR, according to an example embodiment. The example audio processing system 220 may include a device under test (DUT) module 410 and an instantiation generator module 420. The DUT module 410 may be operable to receive the captured audio signal. In some embodiments, the DUT module 410 can send the captured audio signal to instantiations generator module 420. The instantiations generator module 420, in this example, is operable to generate two or more instantiations (in support of respective hypotheses) of a clean speech based on the captured audio signal. The DUT module 410 may then collect the different instantiations of clean speech from the instantiations generator module 420. In various embodiments, the DUT module 410 sends all of the collected instantiations (outputs) to ASR engine 170 (shown in FIG. 1 and FIGS. 3A-C).

In some embodiments, the instantiations generation of the instantiations generator 420 includes obtaining several version of clean speech based on the captured audio signal using noise suppression with different degrees of aggressiveness.

In other embodiments, when the captured audio signal is dominated by noise, multiple instantiations can be generated by a system that synthesizes a clean speech signal instead of enhancing the corrupted audio signal via modifications. The synthesis of a clean speech can be advantageous for achieving high signal-to noise ratio improvement (SNRI) values and low signal distortion. By way of example and not limitation, clean speech synthesis methods are described in U.S. patent application Ser. No. 14/335,850, entitled “Speech Signal Separation and Synthesis Based on Auditory Scene Analysis and Speech Modeling,” filed Jul. 18, 2014, now U.S. Pat. No. 9,536,540, which is incorporated herein by reference in its entirety.

In various embodiments, clean speech is generated from an audio signal. The audio signal is a mixture of a noise and speech. In certain embodiments, the clean speech is generated from synthetic speech parameters. The synthetic speech parameters can be derived based on the speech signal components and a model of speech using auditory and speech production principles. One or more spectral analyses on the speech signal may be performed to generate spectral representations.

In other embodiments, deriving synthetic speech parameters includes performing one or more spectral analyses on the mixture of noise and speech to generate one or more spectral representations. The spectral representations are then used for deriving feature data. The features corresponding to clean speech can be grouped according to the model of speech and separated from the feature data. In certain embodiments, analysis of feature representations allows segmentation and grouping of speech component candidates.

In certain embodiments, candidates for the features corresponding to clean speech are evaluated by a multi-hypothesis tracking system aided by the model of speech. The synthetic speech parameters can be generated based at least partially on features corresponding to the clean speech. In some embodiments, the synthetic speech parameters, including spectral envelope, pitch data, and voice classification data, are generated based on features corresponding to the clean speech.

In some embodiments, multiple instantiations, in support of particular hypotheses, generated using a system for synthesis of clean speech based on synthetic speech parameters are sent to the ASR engine. The different instantiations of clean speech may be associated with different physical objects (e.g., sources of sound) present at the same time in an environment. Data from sensors can be used to simultaneously estimate multiple attributes (e.g., angle, frequency, etc.) of multiple physical objects. Attributes can be processed to identify potential objects based on characteristics of known objects. In various embodiments, neural networks trained using characteristics of known objects are used. In some embodiments, instantiations generator module 420 enumerates possible combinations of characteristics for each sound object and determines a probability for each instantiation in support of a particular hypothesis. By way of example and not limitation, methods for estimating and tracking multiple objects are described in U.S. patent application Ser. No. 14/666,312, entitled “Estimating and Tracking Multiple Attributes of Multiple Objects from Multi-Sensor Data,” filed Mar. 24, 2015, now U.S. Pat. No. 9,500,739, which is incorporated herein by reference in its entirety.

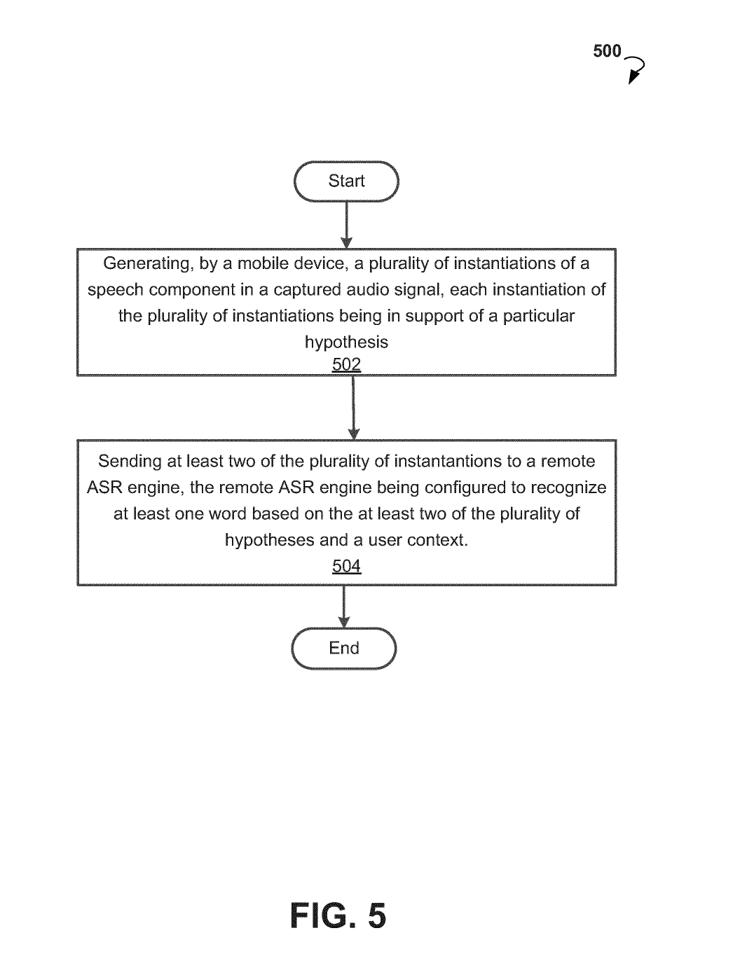

FIG. 5 is a flow chart showing steps of a method 500 for assisting ASR, according to an example embodiment. Method 500 can commence, in block 502, with generating, by a mobile device, a plurality of instantiations of a speech component in a captured audio signal, each instantiation of the plurality of instantiations being in support of a particular hypothesis. In some embodiments, the instantiations are generated by performing noise suppression (including echo cancellation) for the captured audio signal with different degrees of aggressiveness. Those instantiations include audio signals with different voice quality. In other embodiments, the instantiations of the speech component are obtained by synthesizing speech using synthetic parameters. The synthetic parameters (e.g., voice envelope and excitation) can be obtained by spectral analysis of the captured audio signal using one or more voice model(s).

In block 504, at least two of the plurality of instantiations are sent to remote ASR engine. The ASR engine can be provided by at least one cloud-based computing resource. Further, the ASR engine may be configured to recognize at least one word based on the at least two of the plurality of instantiations and a user context. In various embodiments, the user context includes information related to a user, such as location, e-mail, search history, recently recognized words, and the like.

In various embodiments, mobile devices include hand-held devices, such as wired and/or wireless remote controls, notebook computers, tablet computers, phablets, smart phones, smart watches, personal digital assistants, media players, mobile telephones, and the like. In certain embodiments, the audio devices include a personal desktop computer, TV sets, car control and audio systems, smart thermostats, light switches, dimmers, and so on.

In various embodiments, mobile devices include: radio frequency (RF) receivers, transmitters, and transceivers; wired and/or wireless telecommunications and/or networking devices; amplifiers; audio and/or video players; encoders; decoders; speakers; inputs; outputs; storage devices; and user input devices. Mobile devices include input devices such as buttons, switches, keys, keyboards, trackballs, sliders, touch screens, one or more microphones, gyroscopes, accelerometers, global positioning system (GPS) receivers, and the like. Mobile devices include outputs, such as LED indicators, video displays, touchscreens, speakers, and the like.

In various embodiments, the mobile devices operate in stationary and portable environments. Stationary environments can include residential and commercial buildings or structures, and the like. For example, the stationary embodiments can include living rooms, bedrooms, home theaters, conference rooms, auditoriums, business premises, and the like. Portable environments can include moving vehicles, moving persons, or other transportation means, and the like.

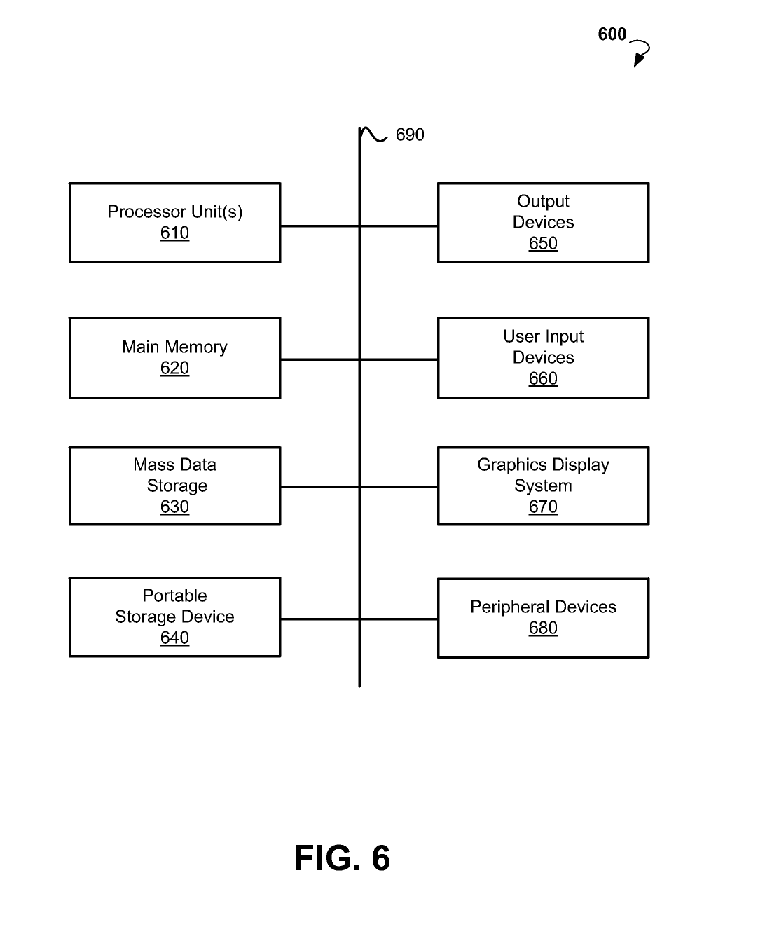

FIG. 6 illustrates an example computer system 600 that may be used to implement some embodiments of the present invention. The computer system 600 of FIG. 6 may be implemented in the contexts of the likes of computing systems, networks, servers, or combinations thereof. The computer system 600 of FIG. 6 includes one or more processor units 610 and main memory 620. Main memory 620 stores, in part, instructions and data for execution by processor unit(s) 610. Main memory 620 stores the executable code when in operation, in this example. The computer system 600 of FIG. 6 further includes a mass data storage 630, portable storage device 640, output devices 650, user input devices 660, a graphics display system 670, and peripheral device(s) 680.

The components shown in FIG. 6 are depicted as being connected via a single bus 690. The components may be connected through one or more data transport means. Processor unit(s) 610 and main memory 620 are connected via a local microprocessor bus, and the mass data storage 630, peripheral device(s) 680, portable storage device 640, and graphics display system 670 are connected via one or more input/output (I/O) buses.

Mass data storage 630, which can be implemented with a magnetic disk drive, solid state drive, or an optical disk drive, is a non-volatile storage device for storing data and instructions for use by processor unit(s) 610. Mass data storage 630 stores the system software for implementing embodiments of the present disclosure for purposes of loading that software into main memory 620.

Portable storage device 640 operates in conjunction with a portable non-volatile storage medium, such as a flash drive, floppy disk, compact disk, digital video disc, or Universal Serial Bus (USB) storage device, to input and output data and code to and from the computer system 600 of FIG. 6. The system software for implementing embodiments of the present disclosure is stored on such a portable medium and input to the computer system 600 via the portable storage device 640.

User input devices 660 can provide a portion of a user interface. User input devices 660 may include one or more microphones, an alphanumeric keypad, such as a keyboard, for inputting alphanumeric and other information, or a pointing device, such as a mouse, a trackball, stylus, or cursor direction keys. User input devices 660 can also include a touchscreen. Additionally, the computer system 600 as shown in FIG. 6 includes output devices 650. Suitable output devices 650 include speakers, printers, network interfaces, and monitors.

Graphics display system 670 include a liquid crystal display (LCD) or other suitable display device. Graphics display system 670 is configurable to receive textual and graphical information and processes the information for output to the display device.

Peripheral device(s) 680 may include any type of computer support device to add additional functionality to the computer system.

The components provided in the computer system 600 of FIG. 6 are those typically found in computer systems that may be suitable for use with embodiments of the present disclosure and are intended to represent a broad category of such computer components that are well known in the art. Thus, the computer system 600 of FIG. 6 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX, ANDROID, IOS, CHROME, TIZEN, and other suitable operating systems.

The processing for various embodiments may be implemented in software that is cloud-based. In some embodiments, the computer system 600 is implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 600, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for assisting automatic speech recognition (ASR), the method comprising:
generating a plurality of instantiations of a speech component in an audio signal, each instantiation of the plurality of instantiations being generated by a different pre-processing performed on the audio signal; and
sending at least two of the plurality of instantiations to a remote ASR engine that is configured to recognize at least one word based on the at least two of the plurality of instantiations.

2. The method of claim 1, wherein generating the plurality of instantiations includes performing noise suppression on the audio signal with different levels of attenuation.

3. The method of claim 2, wherein each of the different levels of attenuation corresponds to a different voice quality of speech (VQOS).

4. The method of claim 3, wherein sending includes sending the at least two of the plurality of instantiations serially in order from best VQOS to worst VQOS.

5. The method of claim 2, wherein performing noise suppression includes performing echo cancellation.

6. The method of claim 1, wherein generating the plurality of instantiations includes generating a plurality of spectral representations of the audio signal.

7. The method of claim 6, wherein generating the plurality of instantiations further includes:
deriving feature data from the plurality of spectral representations; and
generating a plurality of parameters based at least partially on the derived feature data, the parameters including one or both of voice envelope and excitation.

8. The method of claim 7, wherein the plurality of parameters are used by the remote ASR engine to synthesize a plurality of estimates of clean speech.

9. The method of claim 1, wherein the plurality of instantiations comprise a plurality of clean speech estimates.

10. The method of claim 1, wherein generating the plurality of instantiations includes estimating attributes associated with different sources of sound in the audio signal.

11. The method of claim 10, wherein generating the plurality of instantiations further includes assigning a probability to each of the different sources of sound.

12. The method of claim 1, wherein generating the plurality of instantiations includes generating a noise suppressed audio signal from the audio signal that has been captured with a pair of microphones using one or both of differences of waveforms and time of arrival of the audio signal at each of the microphones in the pair.

13. The method of claim 1, wherein the remote ASR engine is configured to recognize at least one word in the audio signal based on the at least two of the plurality of instantiations and a user context.

14. The method of claim 13, wherein the user context includes information related to a user.

15. The method of claim 14, wherein the information includes one or more of location, e-mail, search history and recently recognized words.

16. A device for assisting automatic speech recognition (ASR), the device comprising:
audio processing circuitry adapted to generate a plurality of instantiations of a speech component in an audio signal, each instantiation of the plurality of instantiations corresponding to a particular pre-processing performed on the audio signal; and
a communications interface adapted to send at least two of the plurality of instantiations to a remote ASR engine that is configured to recognize at least one word based on the at least two of the plurality of instantiations.

17. The device of claim 16, wherein the device comprises a mobile device.

18. The device of claim 16, wherein the device comprises a control for an appliance.

19. The device of claim 16, further comprising a microphone adapted to capture the audio signal and provide the captured audio signal to the audio processing circuitry.

20. The device of claim 16, wherein the audio processing circuitry includes noise suppression circuitry adapted to perform noise suppression of the audio signal with different levels of attenuation, wherein each instantiation of the plurality of instantiations corresponds to a different one of the levels of attenuation.

21. The device of claim 20, wherein each of the different levels of attenuation corresponds to a different voice quality of speech (VQOS).
